(19) United States
(12) Patent Application Publication
(10) Pub. No.: US 2005/0284558 A1
(43) Pub. Date: Dec. 29, 2005

(54) Method for manufacturing a carpet

(76) Inventor: Johannes Boerrigter, Twijnspil (NL)

Correspondence Address: HARNESS, DICKEY & PIERCE, P.L.C., P.O. BOX 8910, RESTON, VA, 20195, US

(21) Appl. No.: 11/134,507

(22) Filed: May 23, 2005

(30) Foreign Application Priority Data
May 21, 2004 (NL) 1026245

(51) Int. Cl. B32B 37/00

(52) U.S. Cl. 156/72; 156/283

(57) ABSTRACT

The invention relates to a method for manufacturing carpet, which method comprises the steps of: providing a backing; placing piles into the backing wherein the piles comprise thermoplastic fibres, and the method further comprises the step of: carrying the backing with inserted piles along a heated surface, wherein the underside of the backing lies against the heated surface.

The invention relates to a method for manufacturing carpet, which method comprises the steps of:

providing a backing;

fixing pile threads into the backing.

Such a method is generally used to manufacture carpet. It is important here that the pile threads and the piles formed therewith are properly anchored in the backing. If this does not occur, the pile threads or the fibres of the piles can come loose and cause fuzzing, or traffic can even cause the release of whole piles from the backing.

It is known to apply to the rear of the backing a latex which penetrates well into the piles and after drying thus anchors the piles well into the backing. The drawback of this method is however that much water has to be evaporated out of the latex during the manufacturing process. A large amount of energy is required for the evaporation. In addition, some tens of metres are necessary to evaporate the water from the latex, certainly at a high speed of the length of carpet. If it is desired to increase the production speed, a proportional number of additional metres are then required to enable drying of the latex.

Tests are further being done at the moment with the application of so-called hot-melt adhesives instead of the latex. The hot-melt adhesive is a thermoplast which is heated and, prior to or following heating, is applied to the rear of the backing. The drawback of such hot-melt adhesives is that they are very viscous, whereby they only penetrate with difficulty into the pile threads for anchoring thereof. Satisfactory results have therefore still not been obtained at the moment with such hot-melt adhesives.

It is now an object of the invention to provide a method wherein the piles are properly anchored in the backing, wherein the required energy is decreased, and wherein the great length required when latex is used is avoided.

This object is achieved with a method according to the preamble, which is characterized in that the piles comprise thermoplastic fibres, and that the method further comprises the step of:

carrying the backing with inserted piles along a heated surface, wherein the underside of the backing lies against the heated surface.

When the backing with the piles inserted therein now runs along the heated surface, the thermoplastic fibres in the piles in the area of the contact surface with the heated surface will melt, whereby the fibres of each pile are anchored to each other and to the backing. After leaving the heated surface the thermoplastic fibres will rapidly cool again to a solid state.

The heated surface is preferably the surface of a heated roller.

An embodiment of the method of the invention further comprises the step of applying a thermoplastic adhesive to the underside of the backing. The thermoplastic adhesive, or hot-melt adhesive, no longer need secure the whole pile in the backing as in the prior art, but provides only for an additional anchoring of the parts of the piles protruding on the underside of the backing. The thermoplastic adhesive is preferably applied as an adhesive powder to the underside of the backing prior to the backing being carried along the heated roller. The heated roller herein serves to melt the adhesive together with the fibres in the piles, thereby creating a good adhesion between the piles, the adhesive and the backing.

In another preferred embodiment of the method according to the invention, the thermoplastic fibres comprise polypropylene or polyamide.

In another preferred embodiment, the piles further comprise a non-thermoplastic fibre such as cotton or wool.

Yet another preferred embodiment of the method according to the invention comprises the step of pressing the backing with inserted piles after it has been carried along a heated surface. Owing to this pressing the plasticized fibres are smeared together, thus creating a good mutual adhesion. The smearing together is thus enhanced by the pressing, and it is possible to opt for a lower temperature since the fibres do need to be heated such that they automatically fuse.

In a preferred embodiment, pressing of the backing with inserted piles is brought about by a laminating roller. A laminating roller is normally used to press two layers against each other and so cause them to adhere to each other. In the method according to the invention however, the laminating roller is used to apply a suitable linear pressure to the backing so that the heated parts of the piles can fuse together without the piles having to be heated such that they are completely liquid. Precisely by applying a pressing force after heating a part of the fibres is it possible to obtain a good mutual fusion of the fibres, while the temperature of the heated surface can remain relatively low. Only the underside of the piles has to be heated such that the fibres are plastic and can be pressed together by means of the pressing force. It is not therefore necessary to raise the temperature such that the underside becomes completely liquid and fuses of itself.

These and other features of the invention are further elucidated with reference to the accompanying drawings.

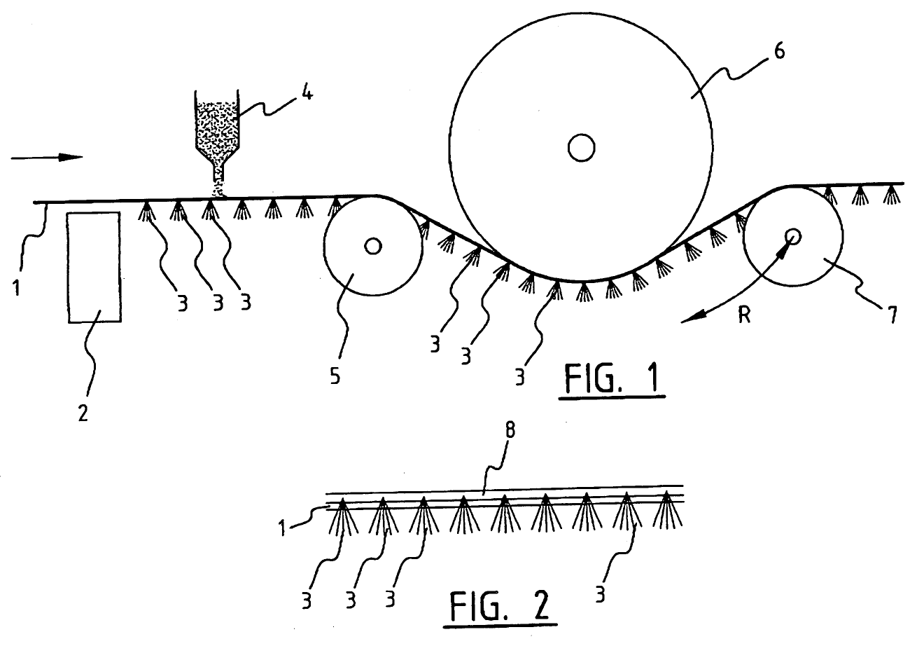

FIG. 1 shows schematically a device for performing the method according to the invention.

FIG. 2 shows a carpet produced with the method according to the invention.

In FIG. 1 a backing 1 is supplied and provided with piles 3 by means of a suitable device 2. An adhesive powder is applied with a sprinkling device 4 to the underside, directed upward in this figure, of backing 1. Backing 1 with piles 3 and adhesive powder 4 is then fed along guide roller 5 and against a heated roller 6. During the entire contact length of backing 1 with the heated roller 6 the adhesive powder from sprinkling device 4 and the thermoplastic fibres in piles 3 can be heated and melt. The backing is subsequently carried away again along a guide roller 7, and the manufactured carpet can cool and be fed to other machines for further processing.

Guide roller 7 can be placed against the heated roller 6 so that it acts as a laminating roller which presses together the backing 1 and the piles 3 arranged therein, so that the plasticized parts of piles 3 can fuse together. The piles will normally spring back after emerging from the pinch between roller 7 and heated roller 6. Piles 3 can optionally also be fluffed by means of a further treatment.

Roller 7 is displaceable in a direction R to thus enable setting of the contact length between backing 1 and heated roller 6. The higher the speed of backing 1 becomes, the greater the contact length will also have to be to provide sufficient time for the adhesive and the thermoplastic fibre to be able to melt. A roller 7 is therefore provided which makes it possible to vary this contact length and whereby the different machines can be started slowly without great lengths of carpet being wasted because the piles have been heated for too long or too short a time. When roller 7 is used as laminating roller, it can then be displaceable in the direction R, although it may sometimes be more advantageous to make roller 5 displaceable instead of roller 7.

FIG. 2 shows a schematic cross-section of a carpet manufactured as according to FIG. 1. The different piles 3 are placed in backing 1 and they protrude, on the top side in the figure, on the rear side of backing 1. Owing to the adhesive powder sprinkled with sprinkling device 4 there is provided on the rear of the backing an adhesive layer 8 which further anchors the protruding pile portions.

A usual foamed latex layer or other finishing layer can further be arranged on such a manufactured carpet.

1. Method for manufacturing carpet, comprising:
providing a backing;
placing piles into the backing,
the piles thermoplastic fibres;
carrying the backing with inserted piles along heated surface, wherein the underside of the backing lies against the heated surface.

2. Method as claimed in claim 1, wherein the heated surface is the peripheral surface of a heated roller.

3. Method as claimed in claim 1, comprising:
applying a thermoplastic adhesive to the underside of the backing.

4. Method as claimed in claim 3, comprising:
applying adhesive powder to the underside of the backing prior to the backing being carried along the heated roller.

5. Method as claimed in claim 1, wherein the thermoplastic fibres comprise at least one of polypropylene and polyamide.

6. Method as claimed in claim 1, wherein the piles further comprise a non-thermoplastic fibre.

7. Method as claimed in claim 1, comprising pressing the backing with inserted piles after it has been carried along a heated surface.

8. Method as claimed in claim 7, wherein the pressing is brought about by a laminating roller.

9. Method as claimed in claim 2, comprising: applying a thermoplastic adhesive to the underside of the backing.

10. Method as claimed in claim 9, comprising:
applying adhesive powder to the underside of the backing prior to the backing being carried along the heated roller.

11. Method as claimed in claim 2, wherein the thermoplastic fibres comprise at least one of polypropylene and polyamide.

12. Method as claimed in claim 2, wherein the piles further comprise a non-thermoplastic fibre.

13. Method as claimed in claim 2, comprising pressing the backing with inserted piles after it has been carried along a heated surface.

14. Method as claimed in claim 13, wherein the pressing is brought about by a laminating roller.
